(19) United States
(12) Patent Application Publication
(10) Pub. No.: US 2013/0187023 A1
(43) Pub. Date: Jul. 25, 2013

(54) Apparatus Stand

(71) Applicant: James Renwick, Santa Monica, CA (US)

(72) Inventor: James Renwick, Santa Monica, CA (US)

(73) Assignee: Nokia Corporation

(21) Appl. No.: 13/354,810

(22) Filed: Jan. 20, 2012

(51) Int. Cl. F16M 13/00

(52) U.S. Cl. 248/683; 248/688; 248/686

(57) ABSTRACT

An apparatus including a housing; and a stand connected to the housing. The stand is configured to cooperate with the housing for the housing and the stand to support the apparatus on a surface. The stand is movable on the housing between a retracted position and an extended position. In the retracted position the stand is substantially flat against the housing. In the extended position the stand projects from the housing with a general triangular shape.

### BACKGROUND

1. Technical Field

The exemplary and non-limiting embodiments relate generally to a stand for a device.

2. Brief Description of Prior Developments

Portable hand held devices have been known which have a stand, such as a fold out arm. For computer tablets, however, an integrated stand has not been provided because of the necessary large size for such a stand. Instead, separate after market tablet stands are available to support a computer tablet in a substantially vertical or inclined position on a surface, such as a desk or table.

### SUMMARY

The following summary is merely intended to be exemplary. The summary is not intended to limit the scope of the claims.

In accordance with one aspect, an apparatus is provided including a housing; and a stand connected to the housing. The stand is configured to cooperate with the housing for the housing and the stand to support the apparatus on a surface. The stand is movable on the housing between a retracted position and an extended position. In the retracted position the stand is substantially flat against the housing. In the extended position the stand projects from the housing with a general triangular shape.

In accordance with another aspect, an apparatus comprises a housing; a stand connected to the housing, a system for retaining the stand at an extended position comprising a magnet. The stand is configured to cooperate with the housing for the housing and the stand to support the apparatus on a surface. The stand has a first section connected to the housing, and a second section movable on the housing between a retracted position and the extended position.

In accordance with another aspect, an apparatus comprises a housing; and a stand connected to the housing. The stand is configured to cooperate with the housing for the housing and the stand to support the apparatus on a surface. The stand comprises at least one rigid member connected by at least one flexible member to the housing. The stand is configured to change shape between a retracted position and an extended position. A portion of the flexible member slides along the housing between the retracted and extended positions.

In accordance with another aspect, a method comprises moving a stand of an apparatus from a retracted position on a housing to an extended position on the housing, where in the extended position the stand has a general triangular shape; and sliding a portion of the stand along the housing as the stand is moved from the retracted position to the extended position, where a magnet in the portion retains the stand at the retracted and extended positions.

In accordance with another aspect, a method comprises providing a stand comprising rigid members connected to each other by a flexible member, where the rigid members are foldable relative to each other at the flexible member; and fixedly connecting an end of the flexible member to a housing of an apparatus, where an opposite end of the flexible member is movable relative to the housing.

### BRIEF DESCRIPTION OF THE DRAWINGS

The foregoing aspects and other features are explained in the following description, taken in connection with the accompanying drawings, wherein:

FIG. 1 is a perspective view of an apparatus comprising features of an example embodiment;

FIG. 2 is a perspective view of the apparatus shown in FIG. 1 from a back side;

FIG. 3 is a perspective view of the back side of the apparatus shown in FIGS. 1-2 with the stand in a retracted configuration;

FIG. 4 is a rear side view of the stand show in FIG. 3;

FIG. 5 is a side view of the apparatus shown in FIG. 1;

FIG. 6 is a bottom plan view of the apparatus as shown in FIGS. 1-2 and 5;

FIG. 7 is a top plan view of the apparatus as shown in FIG. 6;

FIG. 8 is perspective view similar to FIG. 2 showing location of the magnets in the extended position;

FIG. 9 is a rear end view of an alternate example of a rigid member for use in the stand;

FIG. 10 is a rear end view of an alternate example embodiment similar to FIG. 4;

FIG. 11 is a diagram illustrating steps of an example method;

FIG. 12 is a diagram illustrating steps of another example method; and

FIG. 13 is a perspective view of another example embodiment.

### DETAILED DESCRIPTION OF EMBODIMENTS

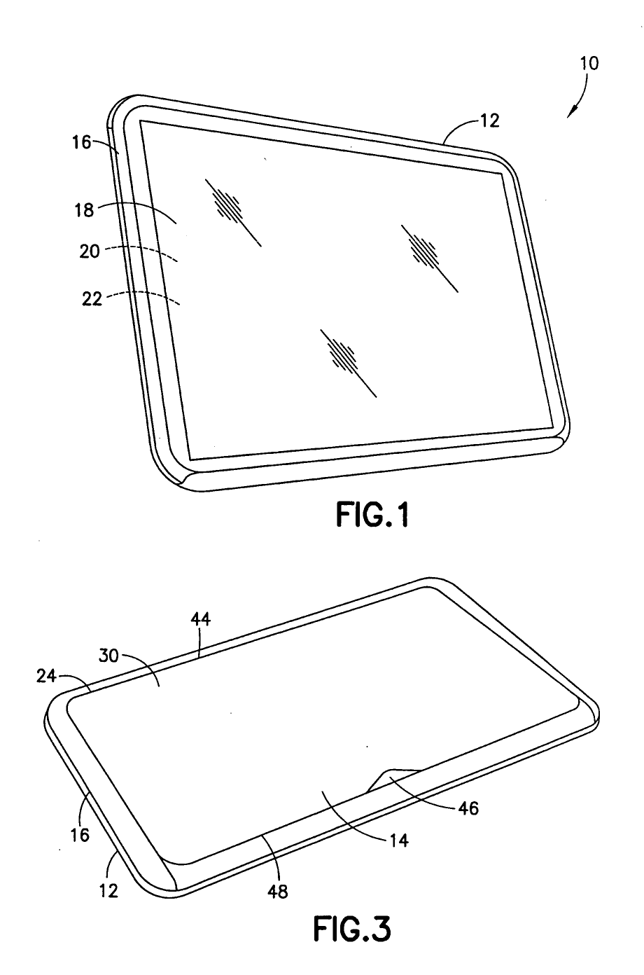

Referring to FIG. 1, there is shown a perspective view of an apparatus 10 incorporating features of an example embodiment. Although the features will be described with reference to the example embodiments shown in the drawings, it should be understood that features can be embodied in many alternate forms of embodiments. In addition, any suitable size, shape or type of elements or materials could be used.

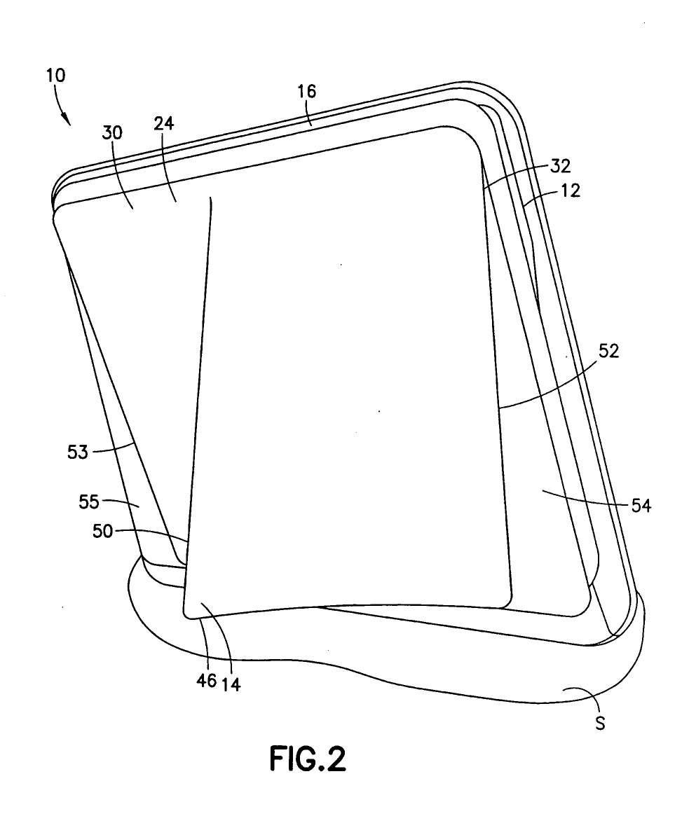

Referring also to FIG. 2, the apparatus 10 in this example comprises a computer tablet 12 and a stand 14. However, features could be used with other types of devices, such as an E-book reader, a PDA, an electrical picture frame viewer, a smart phone, etc. In another example embodiment the stand 14 could be provided as a stand separate from a device, such as integrated in a separate tablet cover for example. The computer tablet includes a housing 16, a touch screen display 18, electronics 20 and a rechargeable battery 22. The electronics 20 can include at least one processor, at least one memory, a transmitter and a receiver, for example.

The stand 14 is located at the rear of the tablet 12. As seen best in FIG. 2, in an extended position the stand 14 and the housing 16 can cooperate to support the apparatus 10 on a surface S, such as a desk or table for example. The stand is able to support the tablet 12 at a substantially vertical, but inclined viewing position on the surface S. Thus, a user can watch a movie or television show or have a web cam conversation (for example) without having to continuously hold the apparatus 10.

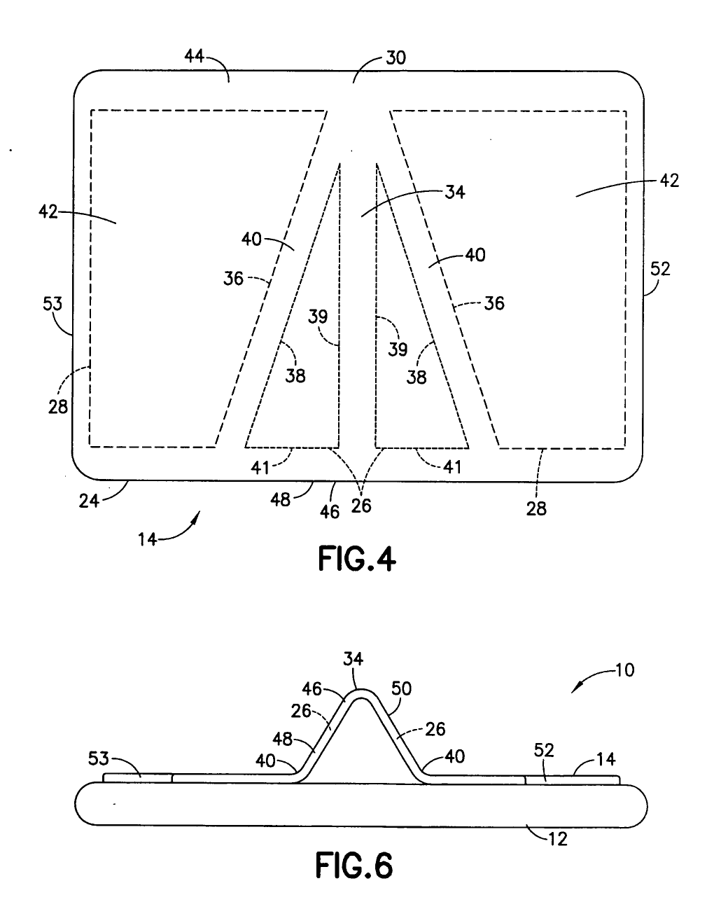

As noted above, FIG. 2 shows the stand 14 in an extended position relative to the tablet 12. Referring also to FIG. 3, the stand 14 also has a retracted position. In the retracted position the stand 14 is substantially flat against the back side of the tablet 12. Referring also to FIG. 4, the stand 14 generally comprises a flexible member 24, rigid members 26, and magnets 28.

The flexible member 24 comprises fabric. The flexible member 24 may additionally or alternatively comprise flexible polymer material such as neoprene for example. In one type of example embodiment the flexible member may comprise multiple different members or materials. The stand 14 has a first section 30 located at a top end of the stand which is fixedly connected to the back side 32 of the tablet 12. The flexible member forms the first section 30, but can be fixedly attached such as with adhesive or compression molding for example. However, any suitable fixed connection could be provided such as any suitable type of mechanical connection or even a removable fixed connection. The flexible member 24 has a general sheet-like configuration.

The rigid members 26 comprise two flat triangle shaped hard plastic members. However, in an alternate example embodiment more or less than two rigid members could be provided, the shapes could be other than triangular, and the material might be semi-rigid and could comprise material other than hard plastic, such as metal for example. In the example embodiment shown, the flexible member 24 is fixedly connected with the rigid members 26, such as with adhesive or overmolding or compression molding for example. The triangle shapes have a general right triangle shape with their 90 degree angles near each other so they are arranged in general reversed or mirror orientations. The flexible member 24 provides a flexible connection forming a fold joint 34 between the rigid members 26.

The magnets 28 comprise two flat polygon or trapezoid shaped members; one at each side end of the flexible member 24. The magnets 28 are permanent magnets, such as made of rare earth materials. However, in an alternate example embodiment more or less than two permanent magnets could be provided, the shapes could be other than trapezoid, and the material might be semi-rigid and could comprise material other than rare earth magnets. In the example embodiment shown, the flexible member 24 is fixedly connected with the magnets 28, such as with adhesive or overmolding or compression molding for example. Each magnet 28 has an edge 36 located opposite an edge 38 of a respective one of the rigid members 26. The flexible member 24 provides a flexible connection forming a fold joint 40 between the respective pairs of edges 36, 38. The back side of the tablet's housing 16 comprises metal. Thus, the magnets 28 magnetically hold the opposite side sections 42 of the stand 14 against the back side of the tablet. However, because the attachment is magnetic, the side sections 42 can move relative to the back side of the tablet. In particular, the example embodiment allows for the side sections 42 to slide along the hark side of the tablet.

As noted above, the first section 30 of the stand 14 is fixedly connected to the back side of the tablet 12. Thus, the first end 44 of the flexible member is at the same position on the back side 32 of the tablet 12 regardless of whether the stand 14 is in the retracted position (FIG. 3) or the extended position (FIG. 2). The ends 48, 52 and 53 are not fixedly connected to the tablet. The ends 48, 52, 53 can move relative to the tablet. When the stand is in the retraced position, the user can pull the middle section 46 of the bottom end 48 of the flexible member 24 outward in order to reconfigure the stand to the extended position.

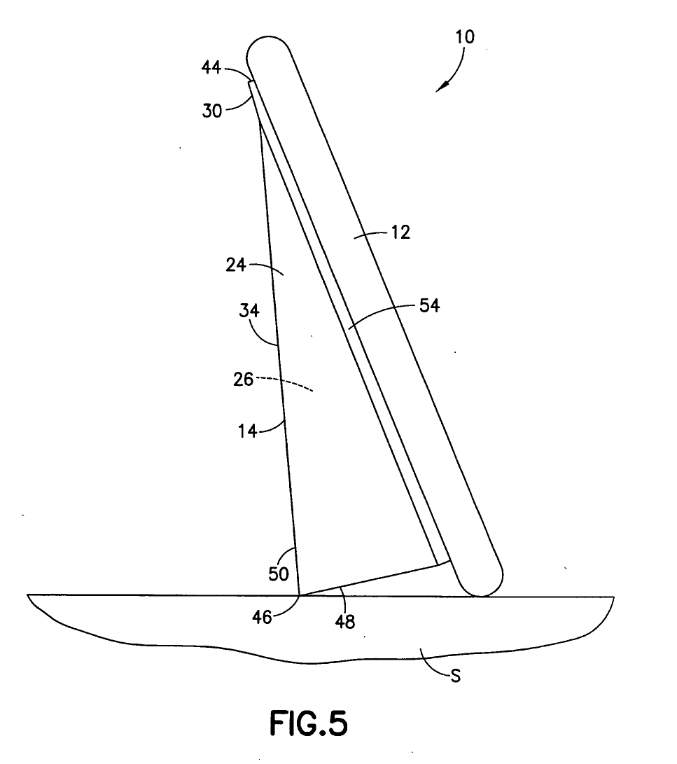

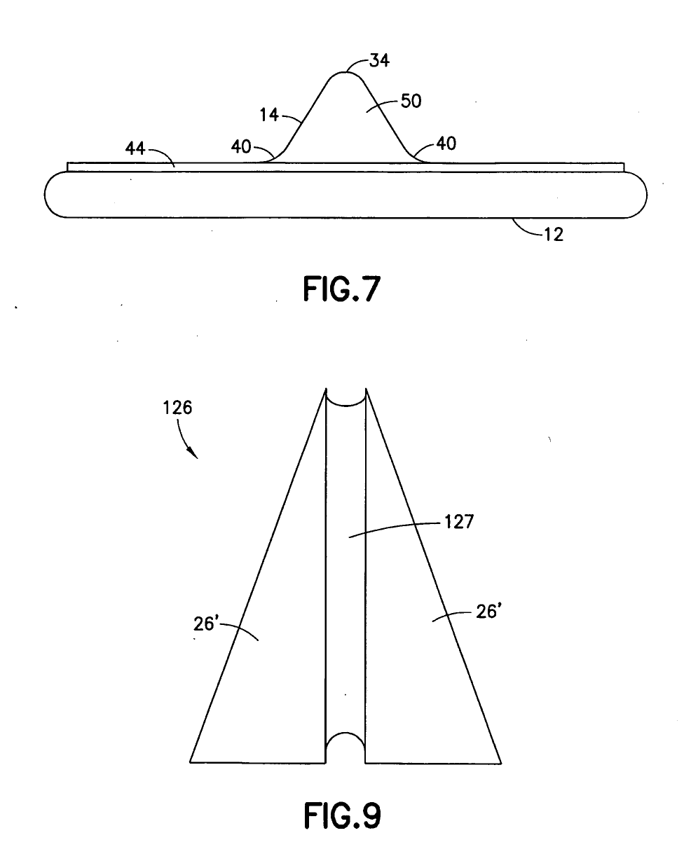

Referring also to FIGS. 5-7, as the middle section 46 of the bottom end 48 is pulled out, the flexible member 24 bends at the fold joint 34 and bends at the fold joints 40 to form a general triangular or pyramid shaped second section 50. The two lateral side ends 52, 53 of the stand 14 are able to move inward in a general curved path. The portions of the side ends 52, 53 closer to the bottom end 48 move a greater distance than the portions of the side ends 52, 53 closer to the top end 44. The flexible member 24 is able to deform or flex to compensate for this movement. The inner facing sides of the stand at the side sections 42 are able to slide along the back side 32 of the tablet 12, but are kept against the tablet by the magnets 28. Thus, areas 54, 55 (see FIG. 2) of the back side 32 of the tablet are uncovered. These areas 54, 55 may comprise decorative colors or patterns for ornamental purposes.

Referring also to FIG. 8, the figure illustrates how the bottoms of the magnets 28 rotate inward towards each other at the extended position versus their position shown in FIG. 4 at the retracted flat position. The rigid members 26 are able to cooperate with the fold joints 34, 40 to provide the reconfigured extended position. Even though the flexible member might be exerting a force to bias the stand back towards the flat retracted position, the magnets 28 can maintain the extended position until changed by a user. The reconfiguration comprises changing the shape of the stand from its flat shape (FIGS. 3-4) to a three-dimensional shape (FIGS. 2 and 5-8) forming a general pyramid shape with the housing 16 of the tablet. The rigid members 26 generally pivot at their sides 38 relative to the housing 16. The rigid members 26 generally pivot relative to each other at their sides 39. The shape of the section 50 resembles a type of fabric pleat but where the rigid members 26 provide rigidity and the side sections 42 are kept against the back side 32 of the tablet. The magnets engage to hold the stand in the upright position. The stand can be kept upright based upon the stiffness of the flexible material 24, stiffness provided by the rigid members (stiffeners) 26, and the magnets 28.

Although the example has been described above as changing shape from the flat configuration to the pyramid projection configuration by “pulling” on the middle section 46 of the bottom end 48, the user could alternative “pinch” opposite sides of the second section towards each other (such as with fingers of a same hand) to move the stand from its retracted configuration to its extended configuration.

In another method of changing shape from the flat retracted configuration to the extended pyramid projection configuration, the user could push the bottoms of the side ends 52, 53 inward with use of both hands. Because the side section 42 are held flat and against the back side 32 of the tablet, the pressure can then cause the fold joints 34, 40 to bend and result in the pyramid projection 50.

In order to reconfigure the stand from its extended position (FIG. 2) back to its flat retracted position (FIG. 3), the user can merely press the second section 50 inward with enough force to have the side sections 42 slide outward back to their home position. The user could perhaps place the tablet 12 parallel to the surface S and push down to accomplish this, or place the display 18 towards the surface S and push down on the second section 50.

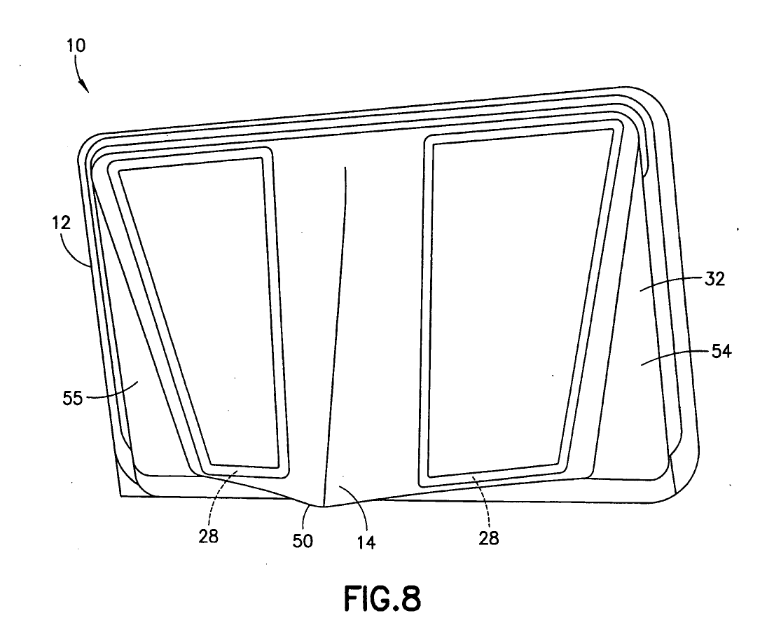

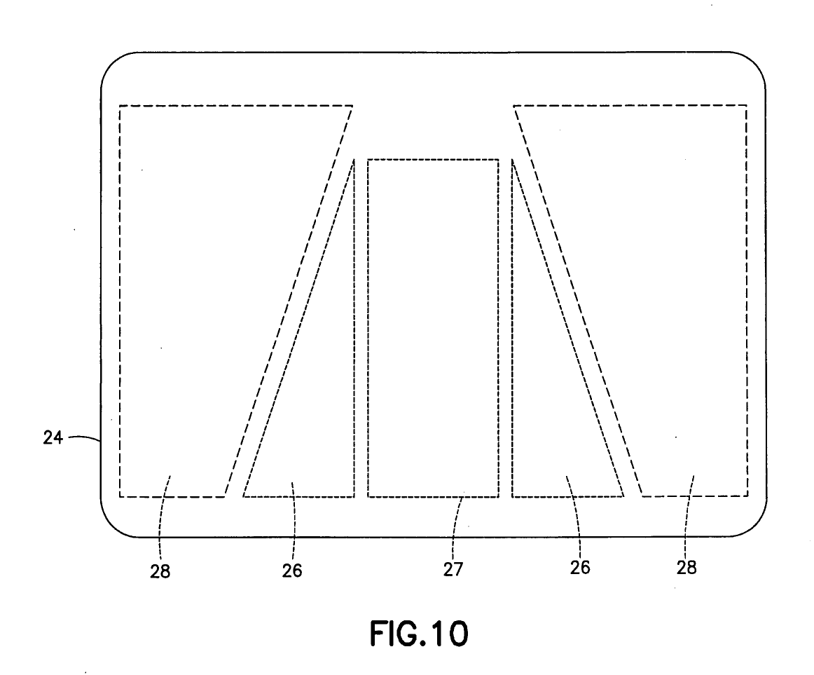

Referring also to FIG. 9, the rigid members 26 of the first example embodiment could be integrally formed as a single member 126 having two sections 26′ connected by an integrally formed, thinner flexible section 127. Referring also to FIG. 10, an alternate example embodiment is shown where the stand comprises three rigid members including the two triangular rigid member 26 and a rectangular rigid member 27.

In another alternate example embodiment rather than the stand 14 having the magnets 28, one or more magnets could be provided in the back side 32 of the tablet, and the magnets 28 could be replaced by metal plates for example. In another example embodiment, rather than the magnets laterally sliding in and out in a general arced path, they could slide up and down with the rigid member being pivoted up and down.

In one type of example embodiment an apparatus 10 may be provided comprising a housing 16 and a stand 14 connected to the housing, where the stand is configured to cooperate with the housing for the housing and the stand to support the apparatus on a surface S, where the stand is movable on the housing 16 between a retracted position (FIG. 3) and an extended position (FIG. 2), where in the retracted position the stand is substantially flat against the housing, and where in the extended position the stand projects from the housing with a general triangular shape.

The general triangular shape may comprise two generally triangular sections 26, where each generally triangular section has a first end 38 located at the housing, a second end 39 at a joint 34 between the two generally triangular sections, and a third end 41 facing a bottom direction of the apparatus. Portions of the stand proximate each of the first ends 38 of the generally triangular sections may comprise magnets 28 slidably along the housing. The generally triangular sections may each comprise a rigid member 26, where the rigid members in each generally triangular section are connected to each other by a flexible member 24 at a joint 34 between the rigid members. Opposite lateral sides 52, 53 of the stand may be configured to be pushed towards each other to move the stand from the retracted position to the extended position. Portions of the stand may be configured to be pinched towards each other to move the stand from the retracted position to the extended position, where the portions are located at the general triangular shape. A portion 46 of the stand may be configured to be pulled out from the housing to move the stand from the retracted position to the extended position, where the portion is a flexible member 24 at a joint 34 in the general triangular shape. The stand may comprise a flexible member 24, rigid members 26 on the flexible member, and magnets 28 on the flexible member, where a first end of the flexible member is fixedly connected to the housing, where the magnets are at second and third ends of the flexible member, where the second and third ends are able to slide along the housing, where the rigid member are located between the second and third ends, and where rigid members fold at a joint between the rigid member provided by the flexible member as the stand moves to the general triangular shape. The apparatus may further comprise means for allowing the stand to obtain the general triangular shape by pinching the stand or pulling on a flexible joint of the stand.

In one type of example embodiment an apparatus 10 comprises a housing 16; a stand 14 connected to the housing, where the stand is configured to cooperate with the housing for the housing and the stand to support the apparatus on a surface, where the stand has a first section 30 connected to the housing, and a second section 50 movable on the housing between a retracted position and an extended position; and a system for retaining the stand at the extended position comprising a magnet 28.

The stand may comprise a flexible member 24 forming the first and second sections, and where the magnet is on the flexible member. The magnet may comprise multiple magnets, where the magnets are on opposite ends of the flexible member. The second section 50 may be located between the magnets 28. The second section 50 may comprise two rigid members 26 on the flexible member 24, where the flexible member forms a fold joint 34 between the rigid members, and where the flexible member forms fold joints 40 between the rigid members and portions of the flexible member having the magnets. The second section 50 may be configured to form a general pyramid shape with the housing in the extended position.

In one type of example embodiment an apparatus 10 comprises a housing 16; and a stand 14 connected to the housing, where the stand is configured to cooperate with the housing for the housing and the stand to support the apparatus on a surface, where the stand comprises at least one rigid member 26 connected by at least one flexible member 24 to the housing, where the stand is configured to change shape between a retracted position and an extended position, where a portion of the flexible member slides along the housing between the retracted and extended positions. The stand may have a substantially flat shape in the retracted position and a section 50 with a general pyramid shape with the housing in the extended position. The portion 42 of the stand which slides along the housing may comprises opposite ends 52, of the flexible member connected to the housing by magnets 28. The at least one rigid member may comprises two triangular shaped flat rigid members 26, where the flexible member 24 forms a fold joint 34 between the rigid members.

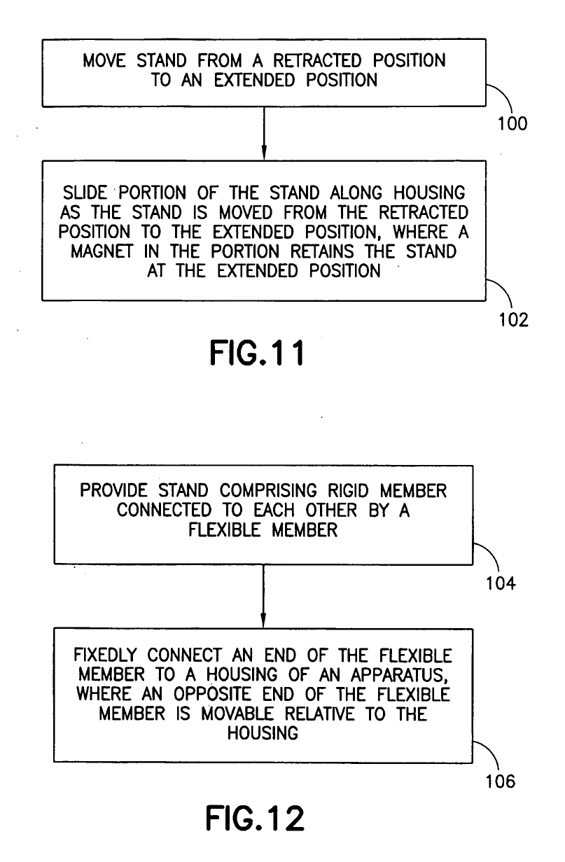

Referring also to FIG. 11, in one type of example embodiment a method comprises moving a stand of an apparatus from a retracted position on a housing to an extended position on the housing as indicated by block 100, where in the extended position the stand has a general triangular shape; sliding a portion of the stand along the housing as the stand is moved from the retracted position to the extended position, where a magnet in the portion retains the stand at the retracted and extended positions as indicated by block 102.

Referring also to FIG. 12, in one type of example embodiment a method comprises providing a stand comprising rigid members connected to each other by a flexible member as indicated by block 104, where the rigid members are foldable relative to each other at the flexible member; and fixedly connecting an end of the flexible member to a housing of an apparatus as indicated by block 106, where an opposite end of the flexible member is movable relative to the housing.

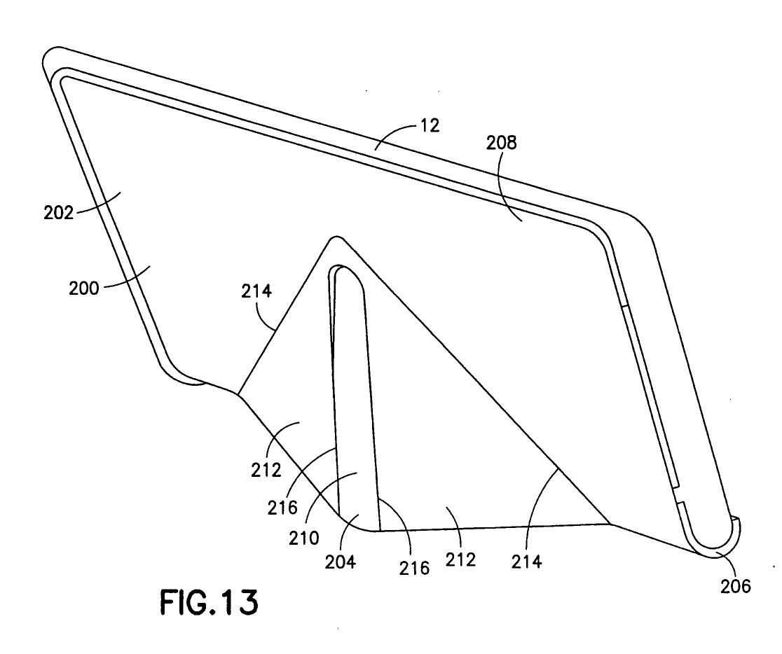

Referring also to FIG. 13, features may be used is a stand apparatus 200 for a tablet 12 which is not integral with the tablet. In this example embodiment the apparatus 200 comprises a housing 202 and a stand 204. The housing 202 has a rigid bottom shelf 206 which is configured to receive and support the bottom side of the tablet 12 therein. The housing includes a rigid back support 208. A back side of the tablet 12 can rest against the front side of the back support 208. The stand 204 comprises a movable member 210 located inside movable flaps 212. Flexible fold joints 214 connect the flaps 212 to the rigid back support 208. An open space is provided between the opposing ends 216 of the flaps 212. FIG. 13 shows the stand in its extended position with a general triangular or pyramid shape. The flaps 212 are substantially rigid to retain this shape. The movable member 210 connects the flaps 212 to each other across the open space between the ends 216. The movable member 210 may comprise magnets or perhaps just a friction engagement to stay with the flaps 212 at the bent position shown in FIG. 13 or at the flat retracted position. Portions of the movable member 210 having the magnets could slide in spaces inside the rigid back support 208, or perhaps merely in spaces inside the flaps 212.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising:
a housing; and
a stand connected to the housing, where the stand is configured to cooperate with the housing for the housing and the stand to support the apparatus on a surface, where the stand is movable on the housing between a retracted position and an extended position, where in the retracted position the stand is substantially flat against the housing, and where in the extended position the stand projects from the housing with a general triangular shape.

2. An apparatus as in claim 1 where the general triangular shape comprises two generally triangular sections, where each generally triangular section has a first end located at the housing, a second end at a joint between the two generally triangular sections, and a third end facing a bottom direction of the apparatus.

3. An apparatus as in claim 2 where portions of the stand proximate each of the first ends of the generally triangular sections comprise magnets slidably along the housing.

4. An apparatus as in claim 2 where the generally triangular sections each comprise a rigid member, where the rigid members in each generally triangular section are connected to each other by a flexible member at a joint between the rigid members.

5. An apparatus as in claim 1 where opposite lateral sides of the stand are configured to be pushed towards each other to move the stand from the retracted position to the extended position.

6. An apparatus as in claim 1 where portions of the stand are configured to be pinched towards each other to move the stand from the retracted position to the extended position, where the portions are located at the general triangular shape.

7. An apparatus as in claim 1 where a portion of the stand is configured to be pulled out from the housing to move the stand from the retracted position to the extended position, where the portion is a flexible member at a joint in the general triangular shape.

8. An apparatus as in claim 1 where the stand comprises a flexible member, rigid members on the flexible member, and magnets on the flexible member, where a first end of the flexible member is fixedly connected to the housing, where the magnets are at second and third ends of the flexible member, where the second and third ends are able to slide along the housing, where the rigid member are located between the second and third ends, and where rigid members are configured to fold at a joint provided by the flexible member between the rigid members to the general triangular shape.

9. An apparatus as in claim 1 further comprising means for allowing the stand to obtain the general triangular shape by pinching the stand or pulling on a flexible joint of the stand.

10. An apparatus comprising:
a housing;
a stand connected to the housing, where the stand is configured to cooperate with the housing for the housing and the stand to support the apparatus on a surface, where the stand has a first section connected to the housing, and a second section movable on the housing between a retracted position and an extended position; and
a system for retaining the stand at the extended position comprising a magnet.

11. An apparatus as in claim 10 where the stand comprises a flexible member forming the first and second sections, and where the magnet is on the flexible member.

12. An apparatus as in claim 11 where the magnet comprises multiple magnets, where the magnets are on opposite ends of the flexible member.

13. An apparatus as in claim 12 where the second section is located between the magnets.

14. An apparatus as in claim 13 where the second section comprises two rigid members on the flexible member, where the flexible member forms a fold joint between the rigid members, and where the flexible member forms fold joints between the rigid members and portions of the flexible member having the magnets.

15. An apparatus as in claim 10 where the second section is configured to form a general pyramid shape with the housing in the extended position.

16. An apparatus comprising:
a housing; and
a stand connected to the housing, where the stand is configured to cooperate with the housing for the housing and the stand to support the apparatus on a surface, where the stand comprises at least one rigid member connected by at least one flexible member to the housing, where the stand is configured to change shape between a retracted position and an extended position, where a portion of the flexible member slides along the housing between the retracted and extended positions.

17. An apparatus as in claim 16 where the stand has a substantially flat shape in the retracted position and a section with a general pyramid shape with the housing in the extended position.

18. An apparatus as in claim 16 where the portion of the stand which slides along the housing comprises opposite ends of the flexible member connected to the housing by magnets.

19. An apparatus as in claim 16 where the at least one rigid member comprises two triangular shaped flat rigid members, where the flexible member forms a fold joint between the rigid members.

20. A method comprising:
moving a stand of an apparatus from a retracted position on a housing to an extended position on the housing, where in the extended position the stand has a general triangular shape;
sliding a portion of the stand along the housing as the stand is moved from the retracted position to the extended position, where a magnet in the portion retains the stand at the retracted and extended positions.

21. A method comprising:
providing a stand comprising rigid members connected to each other by a flexible member, where the rigid members are foldable relative to each other at the flexible member; and
fixedly connecting an end of the flexible member to a housing of an apparatus, where an opposite end of the flexible member is movable relative to the housing.
